(19) United States
(12) Patent Application Publication
(10) Pub. No.: US 2019/0325603 A1
(43) Pub. Date: Oct. 24, 2019

(54) SEATED STATE DETECTION DEVICE

(71) Applicant: AISIN SEIKI KABUSHIKI KAISHA, Kariya-shi (JP)

(72) Inventors: Wataru NOGIMORI, Inazawa-shi (JP); Shunsuke KOGURE, Kariya-shi (JP); Takuya SAKATA, Kariya-shi (JP); Shinichiro MURAKAMI, Kariya-shi (JP)

(73) Assignee: AISIN SEIKI KABUSHIKI KAISHA, Kariya-shi (JP)

(21) Appl. No.: 16/309,377

(22) PCT Filed: Mar. 3, 2017
(86) PCT No.: PCT/JP2017/008612

§ 371 Date: Dec. 12, 2018

(30) Foreign Application Priority Data
Jun. 14, 2016 (JP) 2016-118329
Dec. 16, 2016 (JP) 2016-244277

(51) Int. Cl. G06T 7/73; G06T 7/60; G08B 21/22; B60N 2/00

(52) U.S. Cl. CPC G06T 7/73; G06T 7/60; G08B 21/22; G06T 2207/30204; G06T 2207/10048; G06T 2207/30268; G06T 2207/30196; B60N 2/002

(57) ABSTRACT

A seated state detection device according to an embodiment includes a detection unit, a state determination unit, and an output unit. The detection unit detects, from taken image data output from an imaging unit that images a seat to which a mark is added, whether the mark is shielded. The state determination unit determines a seated state of the seat based on a shielded state of the mark. The output unit outputs seating information indicating the seated state.

### TECHNICAL FIELD

The present invention relates to a seated state detection device.

### BACKGROUND ART

Conventionally, systems have been developed for detecting whether an occupant (a driver, a fellow passenger, and the like) is seated on a seat of a vehicle, that is, a use state of the seat. For example, a device has been developed for comparing an image obtained by photographing a seat with a template that is held in advance, specifying an object present on the seat, and detecting the use state. There is also a device for detecting whether an occupant is seated by using a sensor that senses a temperature of a human body.

### CITATION LIST

### Patent Literature

### [Patent Document 1]

Japanese Patent Application Laid-open No. 2000-39480

### [Patent Document 2]

Japanese Patent Application Laid-open No. 2002-234415

### [Patent Document 3]

Japanese Patent Application Laid-open No. 2004-161087

### [Patent Document 4]

Japanese Patent Application Laid-open No. 2009-513420

### SUMMARY OF INVENTION

### Problem to be Solved by the Invention

In the related art described above, detection accuracy is deteriorated in some cases due to an environment outside the vehicle, an environment inside the vehicle, and the like at the time of detection. For example, in a case of comparing an image obtained by photographing the seat with a template, quality of the image varies depending on disturbance light coming into the inside of the vehicle from the outside of the vehicle, and the image cannot be accurately compared with the template in some cases. In a case of using a visible light camera, detection accuracy is deteriorated in a dark situation such as nighttime. In a case of detecting a temperature of a human body, a seat temperature rises as the temperature inside the vehicle rises, so that discrimination accuracy between the seat temperature and the human body is deteriorated, and the human body cannot be accurately detected in some cases.

An object of the present invention is to provide a seated state detection device that can easily detect a use state (seated state) of the seat more accurately.

### Means for Solving Problem

A seated state detection device according to an embodiment includes, for example, a detection unit configured to detect, from taken image data output from an imaging unit that images a seat to which a mark is added, whether the mark is shielded; a state determination unit configured to determine a seated state of the seat based on a shielded state of the mark; and an output unit configured to output seating information indicating the seated state. With this configuration, for example, whether the mark added to the seat is shielded is detected, so that influence of the environment outside the vehicle or the environment inside the vehicle is hardly caused, and detection accuracy for the use state of the seat can be improved.

In the seated state detection device, for example, the detection unit may detect, as the mark, whether the mark is shielded based on the taken image data obtained by imaging light of a light emitting element incorporated in the seat. With this configuration, the mark itself emits light, so that influence of disturbance light is more hardly caused, for example, and the quality of the taken image data is further improved and accuracy in detecting the seated state can be improved.

In the seated state detection device, for example, the light emitting element may form a pattern of dots arranged in an array. With this configuration, for example, a shielded state of light of the light emitting element can be detected more accurately.

In the seated state detection device, may detect, as the mark, whether the mark is shielded based on the taken image data obtained by imaging the seat to which at least one of a vertical line mark extending in a vertical direction of the seat and a horizontal line mark extending in a horizontal direction of the seat is added. With this configuration, for example, whether the mark is shielded can be easily detected by extracting the “line”, and even in a case in which a relative distance between an imaging unit and the seat varies as a position of the seat in use moves forward, backward, upward, downward, and to the left or light, or the seat is reclined, variation (distortion and the like) in the shape of the mark on the taken image data is little. As a result, even in a case of adjusting the seat to be adapted to the occupant, detection accuracy for the mark can be easily maintained, and whether the mark is shielded can be detected accurately.

In the seated state detection device, at least one of the vertical line mark and the horizontal line mark may be formed by arranging dot-like marks. With this configuration, the shielded state of the mark can be detected by counting the number of dot-like marks, so that the shielded state of the mark can be detected more easily and accurately.

In the seated state detection device, for example, the detection unit may detect whether the mark is shielded based on the taken image data obtained by imaging the seat to which a plurality of the marks are added to a plurality of positions, and the state determination unit may acquire at least one of seated/non-seated state information of the seat, physique information of a user seated on the seat, and seated posture information of the user based on the position of the detected mark. With this configuration, for example, in a case of arranging the mark in the vicinity of a lower part of a backrest surface of the seat, the seated/non-seated state (seated/non-seated state information) can be detected based on the shielded state of the mark. In a case of arranging the mark in the vicinity of an upper part of the backrest surface of the seat, for example, the mark is shielded when a user (a driver, a fellow passenger, or an occupant) is large, and the mark is not shielded when the user is small. As a result, physique information of the user seated on the seat can be obtained based on the shielded state of the mark. In a case of arranging the mark on a side of the backrest surface of the seat, for example, the mark is shielded when the user is seated facing the front, and the mark is not shielded when the user leans on a side opposite to the side on which the mark is added (seated in an inclined posture). As a result, seated posture information of the user can be obtained based on the shielded state of the mark.

In the seated state detection device, for example, the detection unit may detect whether the mark is shielded based on infrared image data as the taken image data. With this configuration, for example, the mark is made of a material that absorbs or reflects infrared rays, and added to the seat. This mark can be detected based on the taken image data imaged by an infrared imaging device, and whether the mark is shielded can be detected. In this case, for example, the mark can be added without impairing a design of the seat, and the mark can be detected, that is, the seated state can be detected while being more hardly influenced by surrounding environment.

In the seated state detection device, for example, the state determination unit may further acquire weight data indicating weight added to the seat, and determines the seated state based on the shielded state of the mark and the weight data. With this configuration, for example, in a case in which a light-weight baggage and the like are put on the seat, the baggage can be discriminated from the user (a driver or a fellow passenger), and detection efficiency for the use state of the seat can be improved.

In the seated state detection device, for example, the detection unit may further detect a length in a longitudinal direction of the mark, and the state determination unit may determine the seated state based on the position and the length of the detected mark. With this configuration, for example, discrimination patterns for shielding of the mark are increased, and the use state of the seat can be determined in more detail.

### BRIEF DESCRIPTION OF DRAWINGS

FIG. 1 is a perspective view illustrating an example of a state in which part of a compartment of a vehicle is drawn in perspective, the vehicle equipped with a seated state detection device according to an embodiment.

FIG. 2 is a schematic diagram for explaining an example of a mark that is added to a seat in the seated state detection device according to a first embodiment and the seat to which the mark is added.

FIG. 3 is a block diagram illustrating an example of a seated state detection system including the seated state detection device according to the first embodiment.

FIG. 4 is a schematic diagram for explaining an example of a shielded state of the mark obtained by the seated state detection device according to the first embodiment.

FIG. 5 is a flowchart for explaining an example of a processing procedure of detecting a seated state performed by the seated state detection device according to the first embodiment.

FIG. 6 is a schematic diagram illustrating an example of the seated state detected by the seated state detection device according to the first embodiment, and explaining the shielded state of the mark in a case in which a large occupant is seated in a normal posture (posture facing the front).

FIG. 7 is a schematic diagram illustrating an example of the seated state detected by the seated state detection device according to the first embodiment, and explaining the shielded state of the mark in a case in which a small occupant is seated in a normal posture (posture facing the front).

FIG. 8 is a schematic diagram illustrating an example of the seated state detected by the seated state detection device according to the first embodiment, and explaining the shielded state of the mark in a case in which a small occupant is seated in a posture of leaning on a door.

FIG. 9 is a schematic diagram illustrating an example of the seated state detected by the seated state detection device according to the first embodiment, and explaining the shielded state of the mark in a case in which a small occupant is seated in a posture of leaning on a door while inclining more largely than FIG. 8.

FIG. 10 is a schematic diagram illustrating an example of the seated state detected by the seated state detection device according to the first embodiment, and explaining the shielded state of the mark in a case in which a large occupant is seated in a posture of leaning on a door.

FIG. 11 is a schematic diagram illustrating an example of the seated state detected by the seated state detection device according to the first embodiment, and explaining the shielded state of the mark in a case in which a large occupant is seated in a posture of leaning on a door while inclining more largely than FIG. 10.

FIG. 12 is a schematic diagram for explaining an example of the shielded state of the mark (light emitting element) obtained by the seated state detection device according to a second embodiment.

FIG. 13 is a schematic diagram for explaining an arrangement pattern of the mark (light emitting element) in the seated state detection device according to the second embodiment.

FIG. 14 is a schematic diagram illustrating an example of the seated state detected by the seated state detection device according to the second embodiment, and explaining the shielded state of the mark in a case in which a large occupant is seated in a normal posture (posture facing the front).

FIG. 15 is a schematic diagram illustrating an example of the seated state detected by the seated state detection device according to the second embodiment, and explaining the shielded state of the mark in a case in which a small occupant is seated in a normal posture (posture facing the front).

FIG. 16 is a schematic diagram illustrating an example of the seated state detected by the seated state detection device according to the second embodiment, and explaining the shielded state of the mark in a case in which a large occupant is seated in a posture of leaning on a door.

FIG. 17 is a schematic diagram illustrating an example of the seated state detected by the seated state detection device according to the second embodiment, and explaining an arrangement example of the mark (light emitting element) that can acquire more detailed information of the seated state of an occupant, and the shielded state of the mark in a case in which a large occupant is seated in a posture of leaning on a door.

### DESCRIPTION OF EMBODIMENTS

The following discloses exemplary embodiments of the present invention. A configuration of the embodiment described below, and a function, a result, and an effect that are obtained through the configuration are merely examples. The present invention can be implemented by a configuration other than the configuration disclosed in the following embodiments, and at least one of various effects based on a basic configuration and derivative effects can be obtained.

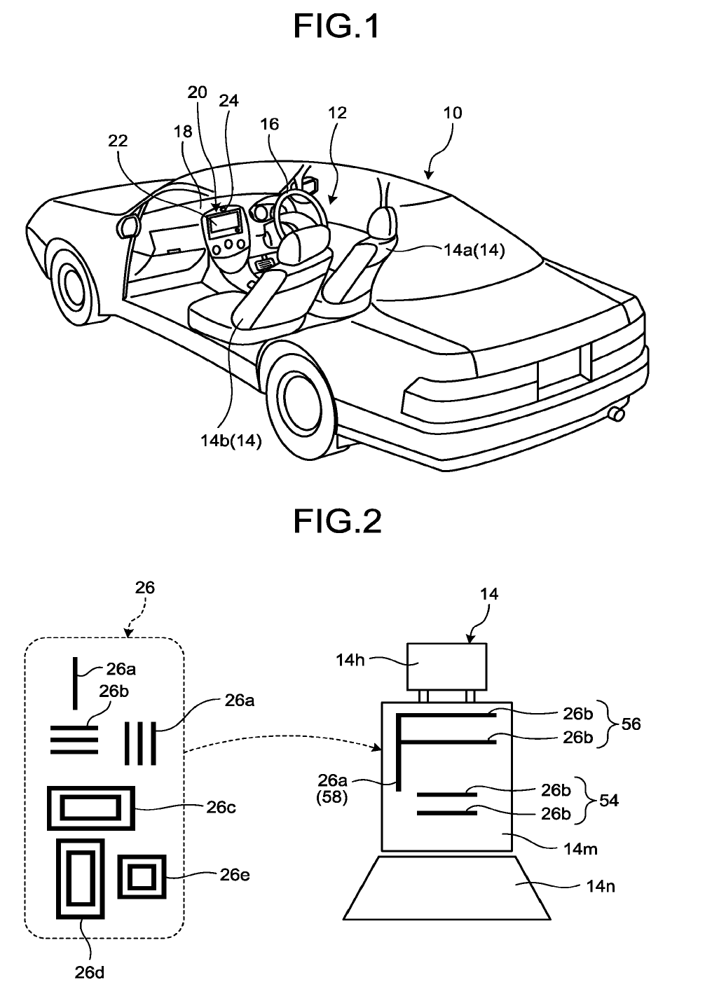

FIG. 1 is a perspective view illustrating an example of a state in which part of a compartment 12 of a vehicle 10 is drawn in perspective, the vehicle 10 equipped with a seated state detection device according to an embodiment. In the present embodiment, the vehicle 10 equipped with the seated state detection device (seated state detection system) may be, for example, an automobile including an internal combustion engine (not illustrated) as a driving source, that is, an internal combustion engine automobile, or an automobile including an electric motor (not illustrated) as a driving source, that is, an electric vehicle or a fuel battery automobile. Alternatively, the vehicle 10 may be a hybrid automobile including both of them as a driving source, or an automobile including another driving source.

As exemplified in FIG. 1, the vehicle 10 configures the compartment 12 in which an occupant (a driver, or a fellow passenger) (not illustrated) rides. In the compartment 12, a seat 14a (driver's seat) for a driver as an occupant, a seat 14b (passenger seat) for a fellow passenger, a rear seat (not illustrated), and the like are disposed. A steering wheel 16, a dashboard 18, and the like are disposed in a state of facing the seats 14a and 14b. A monitor device 20 is disposed at a substantially center part of the dashboard 18 as an information providing unit that provides various pieces of information to a driver or a fellow passenger. The monitor device 20 includes, for example, a display device 22 constituted of a liquid crystal display (LCD), an organic electroluminescent display (OELD), and the like. The monitor device 20 also includes a voice output device (for example, a speaker). The display device 22 is, for example, covered with a transparent operation input unit such as a touch panel. The occupant (a driver or a fellow passenger) can visually recognize an image displayed on a display screen of the display device 22 via the operation input unit. The occupant can perform an operation input by operating (touching, pushing, or moving) the operation input unit with a finger and the like at a position corresponding to the image displayed on the display screen of the display device 22. The monitor device 20 may include an operation input unit such as a switch, a dial, a joystick, and a push button (not illustrated). A voice output device (not illustrated) may be disposed at another position in the compartment 12 separated from the monitor device 20, or voice can be output from a voice output device other than the voice output device of the monitor device 20. The monitor device 20 may also be used as a navigation system or an audio system, for example.

### First Embodiment

The seated state detection system including the seated state detection device according to the first embodiment images the seat 14 to which a mark for detection is added, and detects a seated state of the seats 14a and 14b, and the like based on whether the mark is shielded. Thus, the seated state detection system includes a camera 24 as an imaging unit that images the seats 14a and 14b, and the like. For example, as illustrated in FIG. 1, the camera 24 can be disposed on the monitor device 20 that is positioned at a substantially center part of the dashboard 18. By disposing the camera 24 at this position, both of the seats 14a and 14b can be included in an imaging range, and the seated state of the seats 14a and 14b can be detected with one camera 24. This configuration can contribute to cost reduction. As another example, the camera 24 may be disposed at a position on a driver's seat side of the steering wheel 16 or the dashboard 18 for the seat 14a as the driver's seat, and another camera 24 may be disposed on a passenger seat side of the dashboard 18, for example, in the vicinity of a storage space of an air bag, for the seat 14b as the passenger seat. In this case, the imaging range of each camera 24 can be used exclusively for the respective seats 14, so that a large image of the seat 14 can be obtained within each imaging range, and detection accuracy for the mark can be improved.

The camera 24 may be, for example, a typical visible light camera for visible light, or may be an infrared camera that detects infrared light (infrared rays). As the visible light camera, for example, a digital camera incorporating an imaging element such as a charge coupled device (CCD) can be used. As the mark (described later) added to the seat 14, used is a mark that can be visually recognized. In this case, the mark can be formed, in weaving cloth for covering a surface of the seat 14, by weaving a colored fiber into the cloth in a predetermined pattern (for example, a line pattern). Alternatively, the mark can be attached later to a general-purpose cloth or skin material by painting the mark thereon, or sticking or sewing a single mark piece onto them. In a case of using the visible light camera in this way, there is a wide choice of materials and textures for forming the mark, and there is also a wide choice of cameras, so that a degree of freedom in design can be improved and the cost can be reduced.

On the other hand, as the infrared camera, for example, a digital camera incorporating an imaging element such as a charge coupled device (CCD) can be used, the imaging element having sufficient sensitivity for infrared rays having a predetermined wavelength, specifically, infrared rays in a wavelength region different from that of infrared rays radiated from a human body. The mark added to the seat 14 can be made of a fiber having a property of reflecting or absorbing infrared rays in a wavelength region that can be imaged (detected) with the infrared camera. Such a fiber can be obtained, for example, by using both of dye and infrared absorbent or an infrared reflective agent to be adsorbed by the fiber in a dyeing and finishing process of hydrophobic fiber (for example, polyester fiber and nylon fiber). In this case, the mark can be formed, in weaving the cloth for covering the surface of the seat 14, by weaving infrared absorption fiber or infrared reflection fiber into the cloth in a predetermined pattern (for example, a line pattern). Alternatively, the mark can be attached later to a general-purpose cloth or skin material by painting the mark thereon using infrared absorbent or an infrared reflective agent, or sticking or sewing a single mark piece made of infrared absorption fiber or infrared reflection fiber onto them. The infrared absorbent and the infrared reflective agent do not influence a color of fiber and the like, so that the mark can be prevented from being visually recognized by a person. Thus, a surface design of the seat 14 can be prevented from being impaired by the infrared absorption fiber (absorbent) or the infrared reflection fiber (reflective agent). In a case of performing imaging by the infrared camera, although infrared rays having a predetermined wavelength (infrared rays in a wavelength region different from that of infrared rays radiated from a human body) are emitted toward the seat 14, the infrared rays are not recognized by the occupant, so that occupant's field of vision is not obstructed, and a sense of incongruity is not given to the occupant. In a case of detecting a mark for infrared rays with the infrared camera in detecting the mark of the seat 14 that is not shielded by the occupant and the like, the mark can be detected more clearly than a case of detecting a mark for visible light with the visible light camera. In a case of detecting the mark for infrared rays with the infrared camera, influence of disturbance light or surrounding environment is hardly caused as compared with a case of detecting the mark for visible light, so that the mark can be clearly detected also from this viewpoint. Any other type of camera that can image the mark added to the seat 14 may be used.

FIG. 2 is a schematic diagram for explaining an example of a mark 26 that is added to the seat 14 in the seated state detection device according to the first embodiment and the seat 14 to which the mark 26 is added. The mark 26 is preferably configured in a form of “line”, for example, from a viewpoint of easiness of detection. Examples of the mark 26 include a vertical line mark 26a extending in a vertical direction of the seat 14, a horizontal line mark 26b extending in a horizontal direction of the seat 14, a double horizontally long frame mark 26c, a double vertically long frame mark 26d, and a double square frame mark 26e that are obtained by combining the vertical line mark 26a and the horizontal line mark 26b. The number of the vertical line mark 26a and the horizontal line mark 26b may be one, or a plurality of vertical line marks 26a may be arranged in parallel, and a plurality of horizontal line marks 26b may be arranged in parallel. As described above, the seated state detection device according to the first embodiment detects the seated state based on the shielded state of the mark 26, so that when a plurality of lines are arranged as the mark 26, detection accuracy can be further improved as compared with a case of arranging one line, and a detection form can be increased by increasing a position (detection pattern) at which whether the mark is shielded is detected. For example, as described later, detection of a physique and detection of a seated posture can be facilitated. Similarly, in a case of the double horizontally long frame mark 26c, the double vertically long frame mark 26d, and the double square frame mark 26e, the number of detection targets (lines for determining whether the mark is shielded) can be increased, so that detection accuracy and the detection form can be improved. In a case of the mark for visible light, the form of the mark 26 can be used as the surface design of the seat 14. The mark 26 illustrated in FIG. 2 is merely an example, and the form of the mark can be appropriately modified. The mark 26 may include, for example, a circle, a triangle, other figures or characters, and a geometric design.

The mark 26 is added, for example, to a backrest surface 14m of the seat 14 constituted of the backrest surface 14m (back seat), a seat surface 14n, a headrest 14h, and the like. FIG. 2 illustrates an example in which the mark 26 is added to the backrest surface 14m. The mark 26 may be added to any position within the imaging range of the camera 24 to be shielded when the occupant is seated on the seat 14. As a portion that is necessarily covered by a body when the occupant is seated on the seat 14, the backrest surface 14m is preferably used. In FIG. 2, the marks 26 are added to a plurality of positions of the backrest surface 14m so that the seated state detection device can detect physique information of the occupant, seated posture information of the occupant, and the like in addition to seated/non-seated state information of the occupant. In FIG. 2, two horizontal line marks 26b are added in a lower region of the backrest surface 14m to detect the seated/non-seated state information. In the later description, the horizontal line mark 26b added in the lower region is referred to as a “first mark 54” for detecting the seated/non-seated state information. To detect the physique information of the occupant, two horizontal line marks 26b are added in an upper region of the backrest surface 14m. In the later description, the horizontal line mark 26b added in the upper region is referred to as a “second mark 56” for detecting the physique information. To detect the seated posture information of the occupant, one vertical line mark 26a is added in a side region of the backrest surface 14m (for example, a region on a side opposite to a door). In the later description, the vertical line mark 26a added in the side region is referred to as a “third mark 58” for detecting the seated posture information.

Arrangement of the mark 26 can be appropriately selected depending on a purpose of detection. For example, only the first mark 54 can be added in a case of only detecting whether the occupant is seated. Similarly, only the second mark 56 can be added in a case of detecting a physique of the occupant. In this case, detection accuracy can be improved by also adding the first mark 54. Only the third mark 58 can be added in a case of detecting the seated posture of the occupant. Also in this case, detection accuracy can be improved by also adding the first mark 54. Additionally, depending on the purpose of detection, the double horizontally long frame mark 26c, the double vertically long frame mark 26d, the double square frame mark 26e, and the like may be used together. Depending on a shape and a size of the seat 14 (backrest surface 14m), a position to which the mark 26 is added, the number of positions, and the form of the mark 26 can be appropriately modified.

There is a case in which relative positions of the camera 24 and the seat 14 (backrest surface 14m) are changed. For example, there is a case in which the position of the seat 14 is moved in a vehicle longitudinal direction, or moved in a vertical direction or a horizontal direction to adjust the position of the seat 14. There is also a case in which the backrest surface 14m is reclined. In such a case, when the vertical line mark 26a or the horizontal line mark 26b is used as the mark 26, the shape of the mark 26 is hardly changed (hardly distorted) on taken image data to be imaged even if the relative positions of the camera 24 and the seat 14 (backrest surface 14m) are changed. Thus, by using the vertical line mark 26a and the horizontal line mark 26b for detecting the seated state, whether the mark 26 is shielded can be determined more accurately.

In a case in which the surface of the seat 14 is cloth, as described above, the mark 26 may be formed by weaving infrared absorption fiber or infrared reflection fiber into the cloth, or sticking or sewing, onto the cloth, a piece of cloth including infrared absorption fiber, or infrared reflection fiber or a sheet piece coated with infrared absorbent or an infrared reflective agent. The infrared absorbent or the infrared reflective agent may be directly applied to the seat 14. Alternatively, the mark 26 may be added to a seat cover to be mounted on the seat 14. As described above, in a case in which the mark 26 is detachable from the seat 14, for example, a case in which the mark 26 is added to the seat cover, a piece of cloth, a sheet piece, and the like to be mounted on the seat 14, the position of the mark 26 can be changed depending on the physique of the occupant, a usual seated posture of the occupant, and the like. As a result, detection accuracy for the seated state can be easily adjusted, and a detection item can be easily changed by using the mark 26.

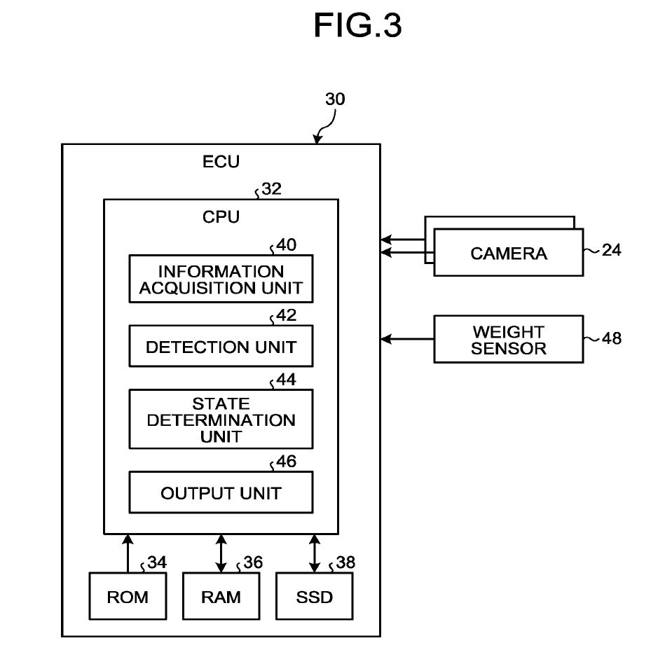

FIG. 3 is a block diagram illustrating an example of the seated state detection system including the seated state detection device according to the first embodiment. An ECU 30 constituting the seated state detection device includes, for example, a central processing unit (CPU) 32, a read only memory (ROM) 34, a random access memory (RAM) 36, and a solid state drive (SSD) 38 (flash memory). The CPU 32 includes various modules to be implemented by reading out and executing a program installed and stored in a non-volatile storage device such as the ROM 34. The CPU 32 includes, for example, an information acquisition unit 40, a detection unit 42, a state determination unit 44, and an output unit 46. The CPU 32 acquires the shielded state of the mark 26, determines the seated state, and reflects a result thereof in control of the vehicle 10. The ROM 34 stores data such as an arithmetic expression and a threshold that are referred to in processing performed by the detection unit 42 and the state determination unit 44 in addition to the program for operating the CPU 32. The RAM 36 temporarily stores various pieces of data used in an arithmetic operation performed by the CPU 32, and temporarily stores taken image data acquired by the information acquisition unit 40. The SSD 38 is a non-volatile rewritable storage unit, and can store data even when the ECU 30 is turned OFF. The CPU 32, the ROM 34, the RAM 36, and the like may be accumulated in the same package. The ECU 30 may be configured to use another logical operation processor such as a digital signal processor (DSP), a logical circuit, and the like in place of the CPU 32. A hard disk drive (HDD) may be disposed in place of the SSD 38, or the SSD 38 and the HDD may be disposed separately from the ECU 30.

The information acquisition unit 40 acquires the taken image data obtained by imaging the seat to which the mark is added output by the camera 24. The information acquisition unit 40 may acquire the taken image data in accordance with an output timing of the camera 24, or may intermittently acquire the taken image data in accordance with a timing of detecting the seated state. In a case in which the mark 26 includes reflective fiber (reflective agent) having a characteristic of reflecting infrared rays having a predetermined wavelength, and the occupant is not present on the seat 14 and the mark 26 is not shielded, infrared rays having a predetermined wavelength emitted from the camera 24 side are reflected by the mark 26. As a result, the information acquisition unit 40 can acquire taken image data (infrared image data) in which the mark 26 (the vertical line mark 26a or the horizontal line mark 26b) is clearly seen to be white with high luminance. In a case in which the mark 26 includes reflective fiber (reflective agent) having a characteristic of absorbing infrared rays having a predetermined wavelength, and the occupant is not present on the seat 14 and the mark 26 is not shielded, infrared rays having a predetermined wavelength emitted from the camera 24 side are absorbed by the mark 26. As a result, the information acquisition unit 40 can acquire taken image data (infrared image data) in which the mark 26 (the vertical line mark 26a or the horizontal line mark 26b) is clearly seen to be black with low luminance (for example, a luminance value is zero).

The detection unit 42 detects whether the mark 26 is shielded based on the taken image data acquired by the information acquisition unit 40. The detection unit 42 extracts the mark 26 from the taken image data using a well-known characteristic extracting method. As an example of the characteristic extracting method, “Hough transform” can be used. Hough transform is a technique used for detecting a white line (straight line) of a road surface, for example, and appropriate for extracting the vertical line mark 26a and the horizontal line mark 26b. In a case in which the vertical line mark 26a and the horizontal line mark 26b added to the seat 14 are not shielded, for example, in a case in which the occupant is not seated, the detection unit 42 can detect the vertical line mark 26a and the horizontal line mark 26b having a reference length (a length in the longitudinal direction of the mark 26 originally added to the seat 14). In contrast, in a case in which the vertical line mark 26a and the horizontal line mark 26b are shielded by a certain object (for example, the occupant) present on the seat 14, the detection unit 42 cannot detect the vertical line mark 26a and the horizontal line mark 26b. In a case in which part of the vertical line mark 26a and the horizontal line mark 26b is shielded, the detection unit 42 can detect a length in the longitudinal direction of a portion of the vertical line mark 26a and the horizontal line mark 26b that is not shielded. As described above, although the vertical line mark 26a and the horizontal line mark 26b are hardly influenced by a change in the relative positions of the camera 24 and the seat 14 (backrest surface 14m), correction may be performed at the time of extracting the mark 26 in accordance with a change of the relative positions. Specifically, by performing correction in accordance with the relative positions in a case of extracting the length of the vertical line mark 26a and the horizontal line mark 26b that are partially shielded, detection accuracy can be further improved.

A method of detecting the mark 26 by the detection unit 42 is not limited to Hough transform. For example, in a case of performing image recognition based on the taken image data, contrast is enhanced and binarization is performed. In this case, if the mark 26 is present in the image, for example, the vertical line mark 26a and the horizontal line mark 26b are turned to be white, and other portions are turned to be black. When differentiation is successively performed, a differential value is suddenly changed at a boundary portion, so that a line present at this portion can be detected. In a case of performing such processing using binarization, the position at which the mark 26 is present in the image is substantially seen. Thus, when such a portion and a surrounding portion are scanned, and if there is an edged portion (a portion at which the differential value is suddenly changed), it can be determined that the vertical line mark 26a or the horizontal line mark 26b is present. This method of using binarization is advantageous in that a processing load of the CPU 32 is smaller than that in a method of using Hough transform.

The state determination unit 44 determines the seated state of the seat 14 based on the shielded state of the mark 26 detected by the detection unit 42. For example, if all the marks 26 added to the seat 14 are detected without being shielded, it is determined that the occupant is not seated on the seat 14. In a case in which part of the mark 26 is detected (a case in which the mark 26 shorter than the reference length is detected), the state determination unit 44 can determine the physique or the seated posture of the occupant seated on the seat 14 in accordance with the position and the length of the mark 26 that is detected without being shielded. Determination made by the state determination unit 44 will be described later in detail.

The output unit 46 outputs seating information based on a determination result of the state determination unit 44 to each appliance and system mounted on the vehicle 10. For example, if it is determined that the occupant is seated on the seat 14, the output unit 46 provides the seating information to a seat belt management system. In a case in which a seat belt of the corresponding seat 14 is not used although information that the occupant is seated on the seat 14 is received, the seat belt management system executes a seat belt warning by displaying a warning light or outputting a warning sound via the monitor device 20, for example. If it is determined that the occupant is seated on the seat 14, for example, the output unit 46 provides the seating information to an air bag control system. Based on whether the occupant is seated on the seat 14, and the physique, the seated posture, and the like of the seated occupant, the air bag control system controls whether to unfold the air bag stored in the steering wheel 16 or the dashboard 18, and a pressure and a timing for unfolding the air bag to appropriately protect the occupant.

A weight sensor 48 is connected to the ECU 30 in addition to the camera 24 that outputs the taken image data obtained by imaging the mark 26 added to the seat 14. The weight sensor 48 is, for example, disposed on a leg part and the like of the seat 14, and outputs weight data indicating weight added to the seat 14 (added weight). When acquiring the weight data, the information acquisition unit 40 provides the weight data to the state determination unit 44. If the weight data is equal to or larger than a predetermined weight threshold, the state determination unit 44 determines that an object other than a baggage, that is, the occupant is present on the seat 14, and performs specific seating detection processing with the mark 26. For example, in a case in which the acquired weight data is smaller than 10 kg, it is determined that a baggage and the like are placed on the seat 14, and the seating detection processing with the mark 26 is stopped to lighten the processing load of the CPU 32. The weight sensor 48 may be disposed not only on the leg part of the seat 14 but also on a center part of a back surface of the seat surface 14n, for example.

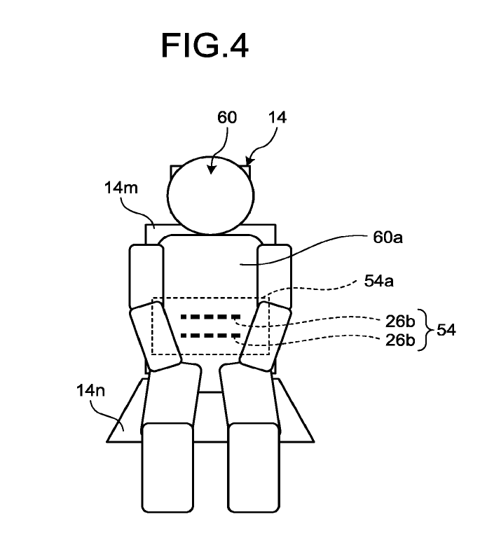

FIG. 4 is a schematic diagram for explaining an example of the shielded state of the mark 26 obtained by the seated state detection device according to the first embodiment. FIG. 4 is an example in which a large occupant 60 is seated on the seat 14 including a first detection region 54a of the seat 14 in which two horizontal line marks 26b (first mark 54) are added. As illustrated in FIG. 4, the first mark 54 is added in a lower region of the backrest surface 14m of the seat 14, so that the first mark 54 can be shielded by a body 60a irrespective of a physique or a seated posture of the occupant 60. That is, the first mark 54 (horizontal line mark 26b) is not present in the taken image data imaged by the camera 24, so that the detection unit 42 cannot detect the first mark 54. As a result, the state determination unit 44 can determine that the occupant 60 is seated on the seat 14.

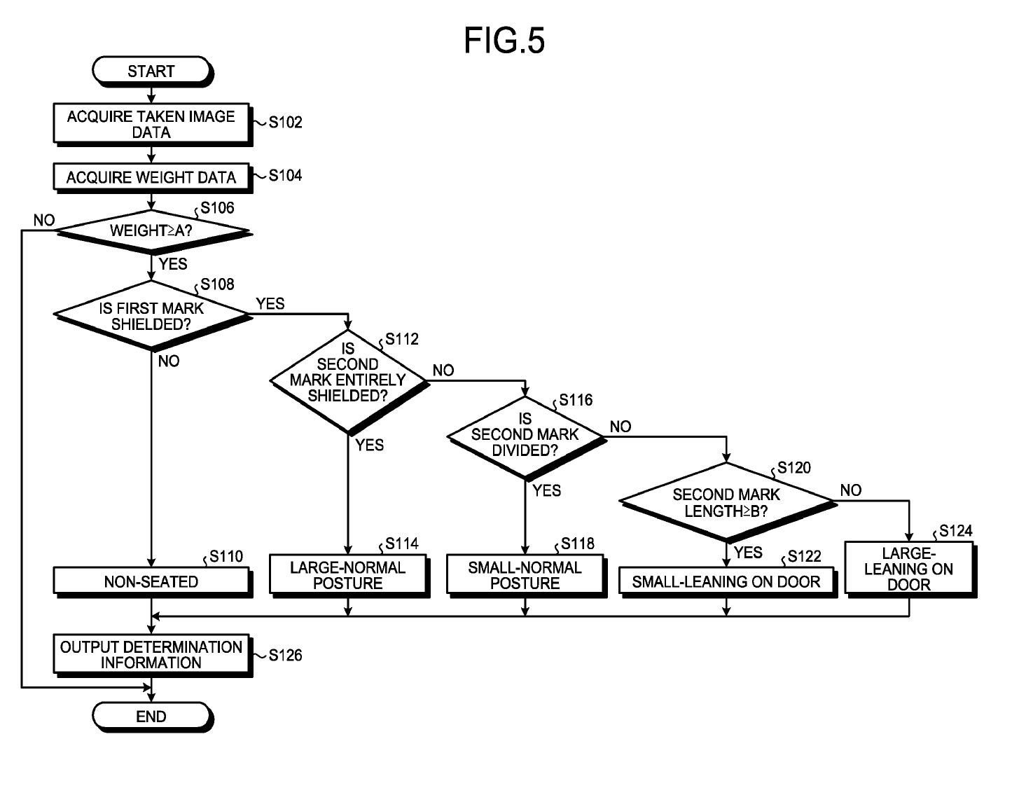

The following describes a processing procedure of detecting the seated state performed by the seated state detection device (details about a determination example obtained by the state determination unit 44) using the flowchart in FIG. 5. By way of example, the flowchart in FIG. 5 explains a case of detecting the seated state of the seat 14 (14b) on the passenger seat side of the vehicle 10 at predetermined processing cycles. As illustrated in FIG. 2, it is assumed that the first mark 54 and the second mark 56 constituted of the horizontal line marks 26b and the third mark 58 constituted of the vertical line mark 26a are added to the backrest surface 14m of the seat 14.

The CPU 32 calls a program for detecting the seated state from the ROM 34, causes the modules such as the information acquisition unit 40, the detection unit 42, the state determination unit 44, and the output unit 46 to be in a state capable of functioning, and causes the camera 24 and the weight sensor 48 to be in a state capable of operating. The information acquisition unit 40 acquires the taken image data from the camera 24 (S102), and acquires the weight data from the weight sensor 48 (S104).

The state determination unit 44 compares a threshold weight A held by the ROM 34 with the acquired weight data. If weight data≥threshold weight A (for example, 10 kg) is not satisfied (No at S106), that is, the weight added to the seat 14 is smaller than 10 kg, the state determination unit 44 determines that some object that is not the occupant (for example, a baggage) may be present on the seat 14, and temporarily ends this procedure.

If it is determined that weight data≥threshold weight A is satisfied (Yes at S106), the state determination unit 44 determines that the first mark 54, the second mark 56, and the third mark 58 added to the backrest surface 14m are in a state of being possibly shielded by an object having a weight equal to or larger than the threshold weight A such as the occupant, and performs seated state detection processing. First, the detection unit 42 performs extraction processing of the mark 26 (processing using Hough transform or binarization) on the taken image data acquired by the information acquisition unit 40. The state determination unit 44 then determines whether the first mark 54 added in the lower region of the backrest surface 14m is shielded based on the detection result of the detection unit 42 (S108). If the first mark 54 (two horizontal line marks 26b) is not shielded (No at S108), that is, if the two horizontal line marks 26b having the reference length are detected in the first detection region 54a in FIG. 4, the state determination unit 44 determines that the occupant is not seated on the seat 14 (14b) as a seated state detection target (S110).

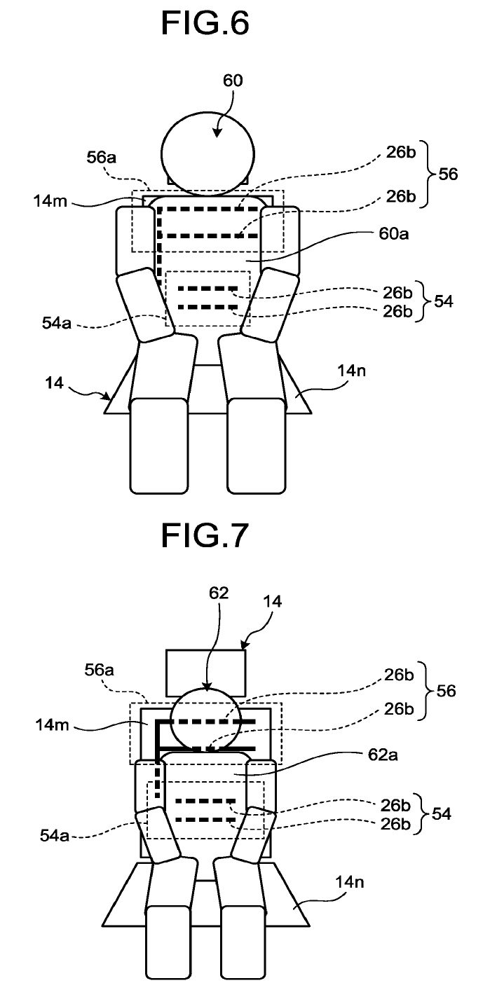

On the other hand, if it is determined that the first mark 54 is shielded at S108 (Yes at S108), the state determination unit 44 checks the shielded state of the second mark 56 (two horizontal line marks 26b) added in the upper region of the backrest surface 14m. That is, after determining that the occupant having a weight equal to or larger than the threshold weight A is seated on the seat 14, the state determination unit 44 checks whether the second mark 56 is entirely shielded (S112). If it is determined that the second mark 56 is entirely shielded (Yes at S112), the state determination unit 44 determines that the large occupant 60 is seated on the seat 14 in a normal posture (S114). Herein, the normal posture means a state of being seated at a substantially center part of the seat surface 14n of the seat 14 while facing the front of the vehicle 10. FIG. 6 is a schematic diagram illustrating a state in which the large occupant 60 is seated on the seat 14 in a normal posture, and the first mark 54 in the first detection region 54a and the second mark 56 in a second detection region 56a added to the backrest surface 14m are completely shielded by the body 60a of the occupant 60. That is, the first mark 54 and the second mark 56 are not detected by the detection unit 42. In such a case, the state determination unit 44 determines that the large occupant 60 is seated on the seat 14 in a normal posture.

On the other hand, if the second mark 56 is not entirely shielded at S112 (No at S112), that is, the detection unit 42 detects part of the second mark 56 (two horizontal line marks 26b), the state determination unit 44 checks whether the second mark 56 is detected in a divided state (S116). If it is determined that the horizontal line mark 26b is divided such that, for example, only a center portion of the second mark 56 (horizontal line mark 26b) is shielded (Yes at S116), the state determination unit 44 determines that a small occupant 62 is seated on the seat 14 in a normal posture (S118). Herein, “the horizontal line mark 26b is divided” means a state in which the horizontal line mark 26b is separated in the longitudinal direction because one horizontal line mark 26b is partially shielded. Thus, a case in which a plurality of marks 26 are arranged at intervals in the longitudinal direction does not mean “the horizontal line mark 26b is divided”. FIG. 7 is a schematic diagram illustrating a state in which the small occupant 62 is seated on the seat 14 in a normal posture. In FIG. 7, the first mark 54 in the first detection region 54a added to the backrest surface 14m is completely shielded, and part of the second mark 56 in the second detection region 56a (for example, a center part) is partially shielded by a body 62a (a head part or a neck part) of the occupant 62. That is, the detection unit 42 does not detect the first mark 54, and detects the second mark 56 (horizontal line mark 26b) in a state of being divided into two parts, for example. In such a case, the state determination unit 44 determines that the small occupant 62 that cannot completely shield the second mark 56 is seated on the seat 14 in a normal posture.

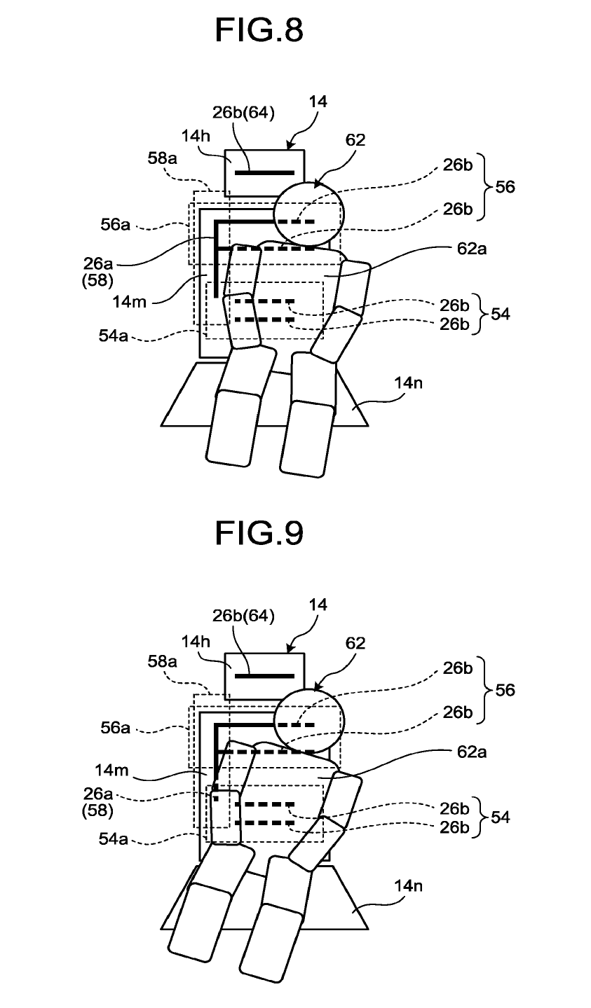

There is a case in which the second mark 56 is not divided at S116 (No at S116), that is, a case in which the detection unit 42 detects part of the second mark 56 (two horizontal line marks 26b), and only one end of the horizontal line mark 26b extending in the horizontal direction is shielded and the horizontal line mark 26b shorter than the reference length is detected by the detection unit 42. In this case, the state determination unit 44 compares the length of the detected second mark 56 in the second detection region 56a with a threshold length B (S120). If it is determined that the length of any one of the two horizontal line marks 26b as the second mark 56 is equal to or longer than the threshold length B (Yes at S120), the state determination unit 44 determines that the small occupant 62 is seated on the seat 14 in a posture of leaning on the door (S122). FIGS. 8 and 9 are schematic diagrams illustrating a state in which the small occupant 62 is seated on the seat 14 in a posture of leaning on the door, and the first mark 54 in the first detection region 54a added to the backrest surface 14m is completely shielded. On the other hand, one end side (for example, the right side) of the second mark 56 in the second detection region 56a is partially shielded by the body 62a (a shoulder part or a neck part) of the occupant 62. In a case in which the occupant 62 shielding the second mark 56 is small and leaning on the door, an occupied area of the backrest surface 14m is small, so that a shield factor of the second mark 56 (horizontal line mark 26b) is reduced. That is, in a case in which the small occupant 62 is seated on the seat 14 in a posture of leaning on the door, the length of the second mark 56 (horizontal line mark 26b) that can be detected without being shielded is increased (second mark length≥threshold length B). In such a case, the second mark 56 is not divided and only a small region thereof is shielded, so that the state determination unit 44 determines that the small occupant 62 is seated on the seat 14 in a posture of leaning on the door.

In a case in which the small occupant 62 is seated on the seat 14 in a posture of leaning on the door, the third mark 58 (vertical line mark 26a) added to the backrest surface 14m on an opposite side of the door is not shielded as illustrated in FIG. 8, or is partially shielded as illustrated in FIG. 9. That is, in a case in which the small occupant 62 is seated on the seat 14 in a posture of leaning on the door, the length of the third mark 58 (vertical line mark 26a) that can be detected without being shielded varies depending on an inclined state of the posture. For example, as compared with the state in FIG. 8, FIG. 9 illustrates a state in which the posture of the small occupant 62 is further relaxed to incline toward the door side (the right side in the drawing). Specifically, in a case of FIG. 8, the occupant 62 is seated at a substantially center part of the seat surface 14n of the seat 14, and the body thereof inclines toward the door side using the seated position as a fulcrum. On the other hand, in a case of FIG. 9, the occupant 62 causes a seated position to be too closer to the driver's seat side of the seat surface 14n to secure a space for largely relaxing the posture, and inclines his/her body toward the door side using the seated position as a fulcrum. In a case of FIG. 8 in which inclination is small, the occupant 62 inclines toward the door side to move away from the third mark 58 added in a third detection region 58a on the driver's seat side, so that a shielded part of the third mark 58 (vertical line mark 26a) of the backrest surface 14m is small (by way of example, the third mark 58 is not shielded in FIG. 8). On the other hand, in a case of FIG. 9 in which inclination is large, the occupant 62 inclines toward the door side after moving toward a direction to the driver's seat (a direction of shielding the third mark 58 added in the third detection region 58a), so that the shielded part of the third mark 58 (vertical line mark 26a) of the backrest surface 14m becomes large (by way of example, the third mark 58 is partially shielded in FIG. 9). That is, the state determination unit 44 can determine that the inclination of the posture is small if third mark length≥threshold length C is satisfied, and can determine that the inclination of the posture is large if third mark length<threshold length C is satisfied. In this way, by comparing lengths of detected third marks 58 with each other in more detail, the state determination unit 44 can detect a degree of the posture of leaning on the door, that is, the seated posture of the occupant 62 in more detail.

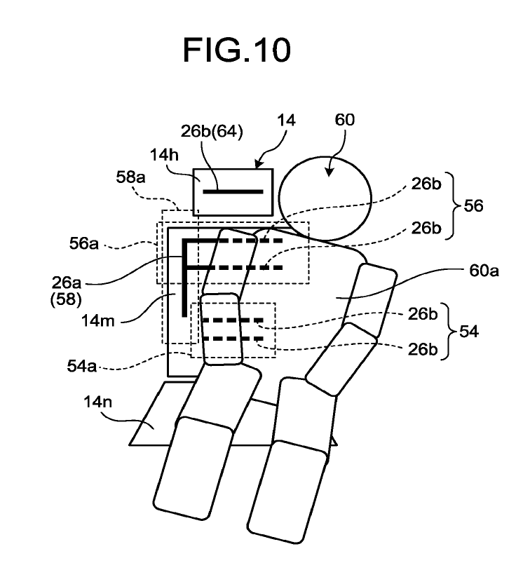

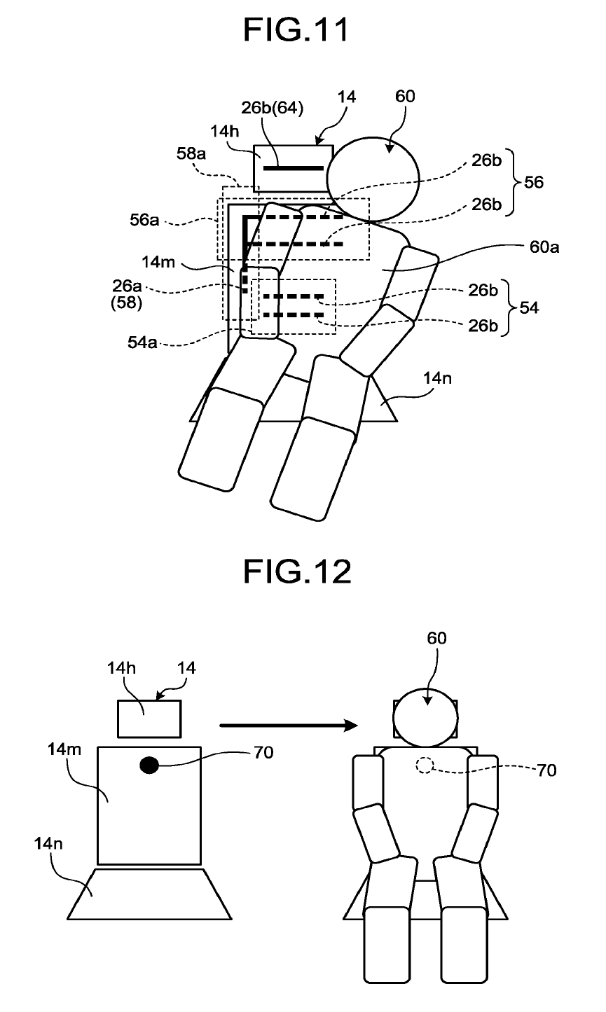

If second mark length≥threshold length B is not satisfied at S120 (No at S120), that is, in a case in which the detection unit 42 detects part of the second mark 56 (two horizontal line marks 26b) and determines that the length of the second mark 56 is smaller than the threshold length B, the state determination unit 44 determines that the large occupant 60 is seated on the seat 14 in a posture of leaning on the door (S124). FIGS. 10 and 11 are schematic diagrams illustrating a state in which the large occupant 60 is seated on the seat 14 in a posture of leaning on the door, and the first mark 54 in the first detection region 54a added to the backrest surface 14m is completely shielded. On the other hand, one end side (for example, the right side) of the second mark 56 in the second detection region 56a is partially shielded by the body 60a (a shoulder part or a neck part) of the occupant 60. In a case in which the occupant 60 shielding the second mark 56 is large and leans on the door, the occupied area of the backrest surface 14m becomes large as compared with a case of the small occupant 62 illustrated in FIGS. 8 and 9, and the shield factor of the second mark 56 (horizontal line mark 26b) is increased. That is, in a case in which the large occupant 60 is seated on the seat 14 in a posture of leaning on the door, the length of the second mark 56 (horizontal line mark 26b) that can be detected without being shielded becomes short (second mark length<threshold length B). In such a case, in a case in which the second mark 56 is not divided and a large region is shielded, the state determination unit 44 determines that the large occupant 60 is seated on the seat 14 in a posture of leaning on the door.

Also in a case in which the large occupant 60 is seated on the seat 14 in a posture of leaning on the door, similarly to the case in which the small occupant 62 is seated in a posture of leaning on the door, the shielded state of the third mark 58 (vertical line mark 26a) may vary. For example, there is a case in which the third mark 58 is not shielded as illustrated in FIG. 10, and a case in which only part of the third mark 58 is shielded as illustrated in FIG. 11. Thus, in a case in which the large occupant 60 is seated on the seat 14 in a posture of leaning on the door, it can be determined that the inclination of the posture is small if third mark length≥threshold length C is satisfied, and that the inclination of the posture is large if third mark length<threshold length C is satisfied. In this way, by comparing the lengths of the detected third marks 58 with each other in more detail, a degree of the posture of leaning on the door, that is, the seated posture of the occupant 60 can be detected in more detail. A value of the threshold length C may be changed depending on whether the occupant leaning on the door is small occupant 62 or the large occupant 60.

In a case of determining the seated state of the seat 14 based on the shielded state of the mark 26 as described above, the state determination unit 44 outputs determination information thereof to another control appliance or a system mounted on the vehicle 10 via the output unit 46 (S126), and temporarily ends a series of seated state detection processing to wait for the next processing cycle.

In the examples of FIGS. 8 to 11, the horizontal line mark 26b is added to the headrest 14h of the seat 14 as a fourth mark 64. The shielded state of the fourth mark 64 (whether the fourth mark 64 is shielded, and a detection length thereof that is detected without being shielded) varies depending on the physique and the seated posture of the seated occupant. In this way, by increasing positions to which the mark 26 is added, the physique and the seated posture of the occupant seated on the seat 14 can be detected in more detail and more accurately. In the example described above, the third mark 58 (vertical line mark 26a) is added on the driver's seat side of the backrest surface 14m. Alternatively or additionally, the third mark 58 (vertical line mark 26a) may be added on the door side. In this case, the occupant can be detected also in a case in which the occupant leans on the driver's seat side.

The seated state detection device according to the first embodiment performs simple processing of detecting whether the mark 26 added to the seat 14 is shielded, so that detection accuracy can be maintained even when the number and types of the mark 26 added to the seat 14 are increased or decreased. In addition to the example of fixing the mark 26 to the seat 14, the mark 26 may be arranged on the seat cover or constituted of small pieces in a detachable manner, so that the number of marks 26 to be formed or an arrangement position thereof can be changed in accordance with a physique, a habitual seated posture, and the like of the occupant. In this case, detection of the seated state appropriate for the occupant (user) who uses the vehicle 10 is easily customized, and versatility can be improved.

In the embodiment described above, as an arrangement example of the mark 26, the first mark 54 is constituted of the two horizontal line marks 26b, the second mark 56 is constituted of the two horizontal line marks 26b, and the third mark 58 is constituted of one vertical line mark 26a, but the embodiment is not limited thereto. The mark 26 can be appropriately modified in accordance with the seated state to be detected and detection accuracy. For example, each of the first mark 54, the second mark 56, and the third mark 58 may be constituted of one vertical line mark 26a or one horizontal line mark 26b, or may be constituted of a plurality of vertical line marks 26a or a plurality of horizontal line marks 26b. Each of the first mark 54 and the second mark 56 may be constituted of the vertical line mark 26a, or the third mark 58 may be constituted of the horizontal line mark 26b.

### Second Embodiment

In the first embodiment described above, described is an example of determining whether the occupant 60 (62) is seated and estimating the physique and the seated posture thereof depending on whether the mark 26 can be detected by the camera 24 when visible light hits the mark 26 (26a, 26b, 26c, 26d, 26e, and the like) added to the backrest surface 14m or the headrest 14h of the seat 14, or when infrared rays having a predetermined wavelength are emitted from the camera 24 side. That is, the mark 26 in the first embodiment is an example of a passive type. On the other hand, in the second embodiment, described is an example of using an active-type mark 70 for determining whether the occupant 60 (62) is seated or estimating the physique and the seated posture of the occupant 60 (62). The following describes an example of using a light emitting element, preferably, an infrared light emitting element that outputs infrared rays as an example of the active-type mark 70.

The mark 70 is added, for example, to the backrest surface 14m of the seat 14 constituted of the backrest surface 14m (back seat), the seat surface 14n, the headrest 14h, and the like. FIG. 12 illustrates an example in which one mark 70 is added to the backrest surface 14m. In a case of using the infrared light emitting element as the mark 70, the infrared light emitting element is an element that outputs infrared rays in a wavelength region different from that of infrared rays radiated from a human body. As the camera 24, a digital camera incorporating an imaging element such as a CCD can be used, the imaging element having sufficient sensitivity for infrared rays having a predetermined wavelength output from the infrared light emitting element constituting the mark 70.

The mark 70 may be added to any position within the imaging range of the camera 24 to be shielded when the occupant is seated on the seat 14. As a portion that is necessarily covered by the body when the occupant is seated on the seat 14, the backrest surface 14m is preferably used.

In a case of using the active-type mark 70, similarly to the first embodiment, the camera 24 cannot detect infrared rays output from the mark 70 in a case in which the occupant 60 is seated on the seat 14. In contrast, in a case in which the occupant 60 is not seated on the seat 14, the camera 24 can detect infrared rays output from the mark 70. Accordingly, whether the occupant 60 is present can be detected in accordance with whether infrared rays are detected. In a case of using the infrared light emitting element as the active-type mark 70, infrared rays having a specific wavelength are used to reduce influence of disturbance light and improve detection accuracy, the infrared rays having a specific wavelength being hard to be seen by human's eyes and hardly contained in light present around the vehicle such as sunlight, city lights, and headlights of other vehicles. In this case, an infrared irradiation device as in the first embodiment becomes unnecessary on the camera 24 side, which contributes to downsizing of the camera 24 and cost reduction. The infrared light emitting element used as the mark 70 can be downsized, for example, an element including a light emitting unit having a diameter of about 1 mm can be used. As a result, the infrared light emitting element is easily embedded in the seat 14. Additionally, even when the infrared light emitting element is embedded in the seat 14, seating comfortableness of the seat 14 is hardly influenced, and seating comfortableness of the usual seat 14 on which the infrared light emitting element is not disposed can be easily maintained. The mark 70 illustrated in the drawing according to the second embodiment is assumed to represent an image of infrared rays (in a diffused state in some degree) detected on the taken image data (on the screen) in a case of imaging the infrared light emitting element with the camera 24. In a case of using the infrared light emitting element as the mark 70, the configuration of the ECU of the seated state detection device is substantially the same as the ECU 30 illustrated in FIG. 3. A processing procedure of detection (estimation) is also substantially the same as the flowchart of FIG. 5 according to the first embodiment. Processing of detecting whether the first mark 54, the second mark 56, and the like are shielded may be replaced with processing of detecting whether the mark 70 of the infrared light emitting element is shielded, so that detailed description thereof will not be repeated.

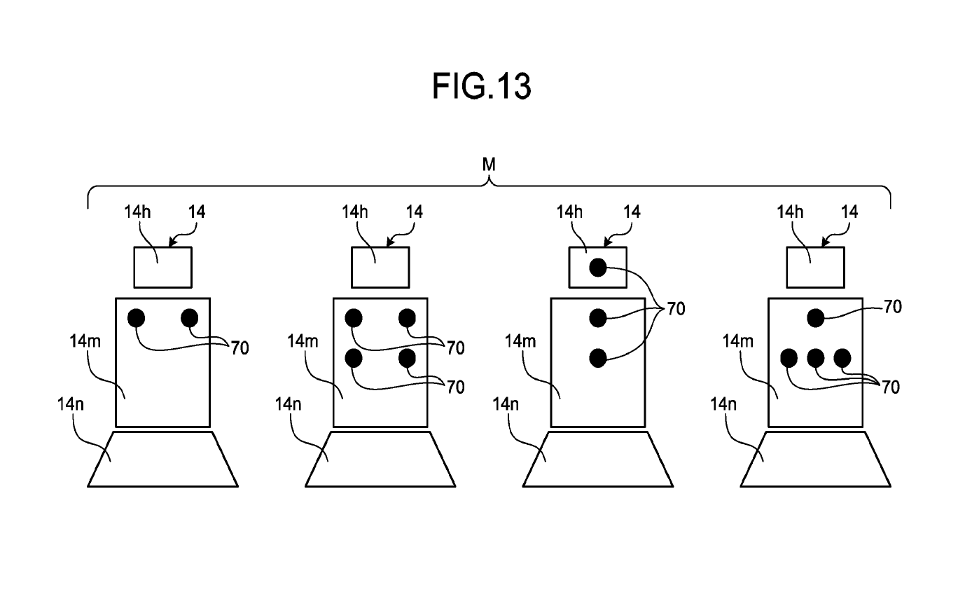

In a case of using the active-type mark 70, similarly to the first embodiment, the physique information of the occupant, the seated posture information of the occupant, and the like can be detected in addition to the seated/non-seated state information of the occupant. FIG. 13 is a schematic diagram illustrating an example of an arrangement pattern M of the infrared light emitting element as the active-type mark 70.

For example, in a case in which two marks 70 are arranged in an array in the horizontal direction as illustrated in the leftmost drawing in FIG. 13, the seated posture information of the occupant, that is, information about whether the occupant is obliquely seated can be acquired in addition to the seated/non-seated state information of the occupant. As illustrated in the second drawing from the left in FIG. 13, in a case in which the two marks 70 are arranged in an array in the vertical direction and an additional such array is arranged to be shifted in the vehicle width direction (2 column arrangement), presence/absence information of the occupant and the seated posture information can be acquired, and information indicating a degree of inclination of the seated posture can be acquired. As illustrated in the second drawing from the right in FIG. 13, in a case in which three marks 70 are arranged in an array in the vertical direction, the physique information of the occupant can be acquired in addition to the presence/absence state information of the occupant. As illustrated in the rightmost drawing in FIG. 13, in a case in which one mark 70 is arranged at the center of an upper row and three marks 70 are arranged in an array in the horizontal direction in a middle row, the physique information of the occupant and the seated posture information of the occupant can be acquired in addition to the presence/absence state information of the occupant.

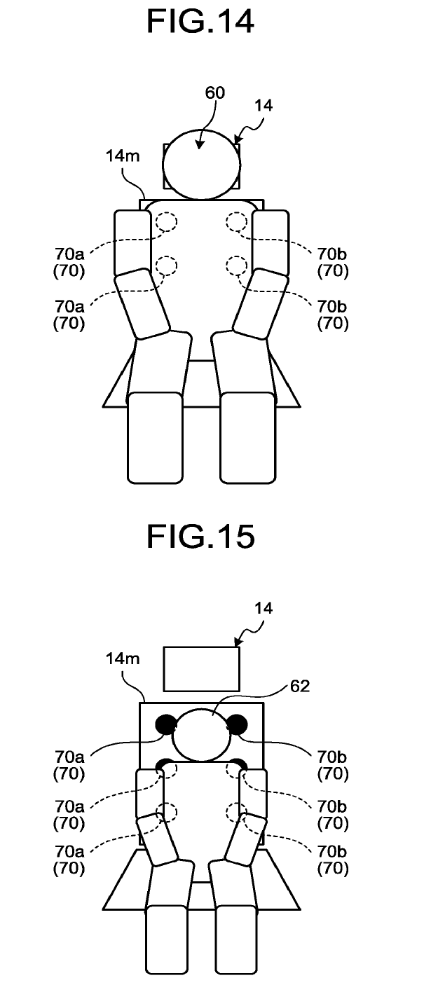

In this way, depending on the arrangement of the active-type mark 70 (infrared light emitting element) (a pattern of dots arranged in an array), various pieces of information can be acquired. With reference to FIGS. 14 to 17, the following describes the shielded state of the mark 70 by the occupant in detail. Regarding FIGS. 15 to 17, an arrangement pattern of the mark 70 different from that in FIG. 13 is used for description to indicate diverse variations.

FIG. 14 illustrates a case in which two marks 70a (70) are arranged in an array in the vertical direction (vehicle height direction) on the backrest surface 14m of the seat 14, and two marks 70b (70) constituting a similar array are arranged to be shifted in the vehicle width direction (same as the second drawing from the left in FIG. 13). In a case of this arrangement pattern, the presence/absence state information and the seated posture information of the large occupant 60 can be acquired, and a degree of inclination of the seated posture can be estimated. For example, in a case in which the large occupant 60 is seated in a normal posture (posture facing the front), as illustrated in FIG. 14, all the marks 70 are not detected. In contrast, in a case in which the occupant 60 is not seated, all the marks 70 are detected. For example, in a case in which the seat 14 is a passenger seat of a right-hand drive vehicle and the occupant is estimated to be seated while largely inclining to (leaning on) the door side, for example, upper and lower marks 70a on the driver's seat side are detected, and in a case in which the occupant is estimated to be seated while slightly inclining, the upper mark 70a is detected and the lower mark 70a is not detected. In a case in which the occupant is seated while inclining to the opposite side, similarly, the seated posture can be estimated depending on whether the upper and lower marks 70b are detected.

FIG. 15 illustrates an example in which the number of marks 70 are increased to discriminate the small occupant 62 seated on the seat 14. In this example, three marks 70a (70) are arranged in an array in the vertical direction (vehicle height direction) on the backrest surface 14m of the seat 14, and three marks 70b (70) constituting a similar array are arranged to be shifted in the vehicle width direction on the backrest surface 14m. With this arrangement pattern, in a case in which the occupant 60 (62) is not seated, all the marks 70 can be detected. On the other hand, in a case in which the large occupant 60 (refer to FIG. 14) is seated, all the marks 70 are not detected similarly to FIG. 14. In a case in which the small occupant 62 is seated, as illustrated in FIG. 15, the marks 70 (70a, 70b) in the upper row can be detected. Depending on the physique of the occupant 62, the marks 70 (70a, 70b) in the middle row can also be detected. That is, in a case in which part of the marks 70 can be detected, it can be estimated that the small occupant 62 is seated. Also in a case of FIG. 15, the seated posture of the occupant 60 (62) can be estimated. For example, similarly to the example of FIG. 14, whether the seated posture is inclined and a degree of inclination can be estimated based on whether the marks 70 (70a, 70b) arranged in the vertical direction are detected. Additionally, whether the seated posture is inclined and a degree of inclination can be estimated depending on the number of left and right marks (70a, 70b) that are detected. For example, the number of detected marks 70 is different between the left and the right, the occupant 62 is estimated to be inclined toward a side on which the number of detected marks is small.

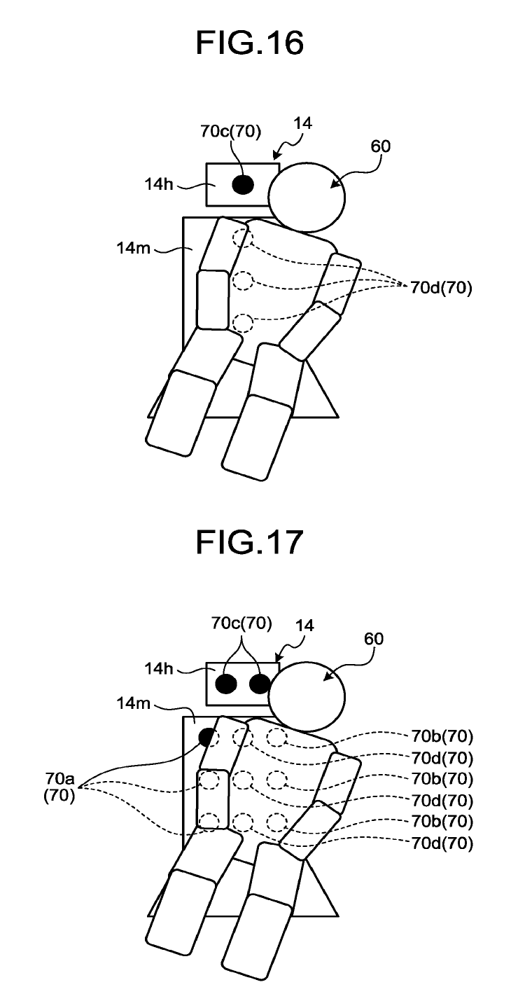

FIG. 16 illustrates a case in which one mark 70c (70) is arranged on the headrest 14h of the seat 14, and three marks 70d (70) are arranged in an array in the vertical direction at a substantially center position in a width direction of the backrest surface 14m of the seat 14. With this arrangement pattern, the presence/absence state information and the seated posture information of the large occupant 60 can be acquired. For example, in a case in which the large occupant 60 is seated in a normal posture (posture facing the front), as illustrated in FIG. 16, all the marks 70c and 70d are not detected. In contrast, in a case in which the occupant 60 is not seated, all the marks 70c and 70d are detected. For example, in a case in which the seat 14 is a passenger seat of a right-hand drive vehicle and the occupant is estimated to be seated while inclining to (leaning on) the door side, the mark 70c arranged on the headrest 14h is detected, and the mark 70d arranged on the backrest surface 14m is not detected. In a case in which the weight data can be acquired from the weight sensor 48 disposed on the seat 14 and the mark 70c is detected, it can be determined that the mark 70c can be detected because the large occupant 60 is seated while inclining, or because the small occupant 62 (refer to FIG. 15) is seated and the mark 70c is not shielded. As a result, the large occupant 60 and the small occupant 62 can be discriminated from each other, and the seated posture information can be acquired.

FIG. 17 is an example of the arrangement pattern of the mark 70 for acquiring the presence/absence state information and the physique information of the occupant 60 (62) seated on the seat 14, and estimating the seated posture information and a degree of inclination. In this example, two marks 70c (marks 70) are arranged in an array on the headrest 14h, and three marks 70a, 70b, and 70d (nine marks 70 in total) are arranged in a matrix array in each of the width direction and the vertical direction of the backrest surface 14m. With this arrangement pattern, in a case in which the occupant 60 (62) is not seated, all the marks 70 can be detected. On the other hand, in a case in which the large occupant 60 is seated in a normal posture (posture facing the front), all the marks 70 are not detected. On the other hand, in a case in which the large occupant 60 is estimated to be seated while inclining as illustrated in FIG. 17, the mark 70c arranged on the headrest 14h is detected. In this case, the number of marks 70c to be detected varies depending on a degree of inclination of the seated posture of the large occupant 60. For example, in a case in which the seated posture is estimated to be slightly inclined, only one of the two marks 70c on the headrest 14h is detected. In a case in which the seated posture is estimated to be largely inclined, both of the two marks 70c are detected. In a case in which the posture is estimated to be more largely inclined, the mark 70a in the upper row on the backrest surface 14m is detected. In a case in which the posture is estimated to be further largely inclined, the number of marks 70a to be detected is increased depending on a degree of inclination. In a case in which the occupant 60 inclines in a reverse direction, the number of marks 70b to be detected is increased depending on a degree of inclination.

In a case in which the small occupant 62 is seated, the mark 70c on the headrest 14h is detected, and the mark 70a and the mark 70b in the upper row of the backrest surface 14m are detected. In a case in which the small occupant 62 is estimated to be seated in an inclined posture, the mark 70d in the upper row is detected in addition to the mark 70a or the mark 70b in the upper row of the backrest surface 14m. For example, in a case in which the small occupant 62 is estimated to be in a posture inclined to the door side, the marks 70a and 70d in the upper row are detected. In contrast, in a case in which the posture is estimated to be inclined to the driver's seat side, the marks 70b and 70d in the upper row are detected.

In this way, by increasing the number of marks 70 arranged on the seat 14, detailed information about the occupant 60 (62) seated on the seat 14 can be acquired.

The arrangement (array) patterns of the mark 70 illustrated in FIGS. 12 to 17 are merely examples, and can be appropriately modified depending on an item to be detected. The line pattern described in the first embodiment may be formed with the arrangement of infrared light emitting elements described in the second embodiment. In this way, the first mark 54, the second mark 56, or the third mark 58, that is, the marks 26 (26a, 26b, 26c, 26d, 26e, and the like) in the first embodiment may be formed in a dot pattern of infrared light emitting elements arranged in an array. In this case, detection and estimation can be performed similarly to the first embodiment, and the detection unit 42 can easily and accurately detect whether the line pattern is present and the length of the line pattern by counting the number of dots of the infrared light emitting elements without using Hough transform and the like. As a result, the processing load of the CPU 32 can be lightened, and the CPU 32 that has lower performance and is inexpensive can be used, which contributes to cost reduction. The first mark 54, the second mark 56, the third mark 58, and the like according to the first embodiment, that is, the marks 26 (26a, 26b, 26c, 26d, 26e, and the like) may be constituted of a light emitting tube that emits light linearly. The light emitting tube may have elasticity (flexibility). In this case, the infrared irradiation device of the camera 24 can be omitted, which contributes to downsizing of the camera 24, cost reduction, and the like. In addition, the first mark 54, the second mark 56, the third mark 58, and the like that have a linear shape and spontaneously emit light, that is, the marks 26 (26a, 26b, 26c, 26d, 26e, and the like) are easily formed as compared with a case in which dots are arranged to form the marks 26, and a discrimination property of the first mark 54, the second mark 56, the third mark 58, and the like (marks 26) is further improved. In a case of using a flexible light emitting tube, a degree of freedom in the shape of the first mark 54, the second mark 56, the third mark 58, and the like (marks 26) can be further improved, which also contributes to improvement of the discrimination property of the mark 26.

In the second embodiment, described is an example in which the infrared light emitting element is used as the mark 70. A type of light to be emitted can be appropriately selected depending on a use so long as a configuration that can spontaneously emit light is included therein, and an effect similar to that of the second embodiment can be obtained.

In the above embodiments, described is a case of detecting the seated state of the passenger seat. The seated state of the driver's seat and the seated state of the rear seat can be detected with a similar configuration, so that a similar effect can be obtained. In a case of detecting the seated state of the rear seat, the camera that images the rear seat can be disposed at a position of a room lamp at a roof center part, for example. Also in this case, an image of the entire rear seats may be taken by one camera, or a camera may be prepared for each rear seat (for example, for three seats) to individually image each rear seat. In a case in which the backrest surface 14m and the headrest 14h of a front seat does not interfere with the imaging range of the rear seat, for example, a camera may be disposed at the position of the room mirror to image the entire seats with one camera. In this way, the disposing position and the number of cameras 24 can be appropriately changed so long as the mark 26 of the seat 14 can be included in the imaging range, and an effect similar to that of the above embodiments can be obtained.

In the above embodiments, the seat 14 of the vehicle 10 is indicated as a detection target of the seated state detection device, but the embodiment is not limited thereto. For example, the embodiments may be applied to a seat of a mobile object such as an electric train, an airplane, and a ship, a seat of a non-mobile object (a fixed seat inside or outside a building), and the like, and a similar effect can be obtained. For example, the embodiments can also be applied to a case of detecting a seated state of a seat in an amusement facility and the like, and a similar effect can be obtained. For example, in a case of a roller coaster and the like, occupants who rides thereon have various physiques, so that fitting control of a seat belt suitable for the physique of the occupant can be performed more accurately and precisely.

The flowchart corresponding to the first embodiment illustrated in FIG. 5 is merely an example. It is sufficient that shielded states of the marks 26 (26a, 26b, 26c, 26d, 26e, and the like) are successively determined. A determination order and a determination criterion can be appropriately changed depending on the form and the number of the marks 26 to be detected, and a similar effect can be obtained. The same applies to a case of applying this flowchart to the second embodiment.

In the first embodiment, described is an example in which the first mark 54, the second mark 56, the third mark 58, and the like, that is, the marks 26 (26a, 26b, 26c, 26d, 26e, and the like) have the line pattern. In another embodiment, the first mark 54, the second mark 56, the third mark 58, and the like may be formed by arranging dot-like marks (a circular shape, a rectangular shape, and a dot having another shape). Also in this case, similarly to the second embodiment, by counting the number of dots constituting the mark added to the backrest surface 14m, the headrest 14h, and the like, presence and the length of the first mark 54, the second mark 56, the third mark 58, and the like (marks 26) can be easily and accurately acquired without using Hough transform and the like. As a result, the processing load of the CPU 32 can be lightened, and the CPU 32 that has lower performance and is inexpensive can be used, which contributes to cost reduction.

The embodiments and modifications of the present invention have been described above. These embodiments and modifications are merely examples, and do not intend to limit the scope of the invention. These novel embodiments can be implemented in various other forms, and can be variously omitted, replaced, and modified without departing from the gist of the invention. These embodiments and modifications thereof are encompassed by the scope and gist of the invention, and encompassed by the invention described in CLAIMS and equivalent thereof.

### EXPLANATIONS OF LETTERS OR NUMERALS

10 VEHICLE
12 COMPARTMENT
14 SEAT
14m BACKREST SURFACE
14n SEAT SURFACE
14h HEADREST
24 CAMERA
26, 70 MARK
26a VERTICAL LINE MARK
26b HORIZONTAL LINE MARK
30 ECU
32 CPU
34 ROM
36 RAM
40 INFORMATION ACQUISITION UNIT
42 DETECTION UNIT
44 STATE DETERMINATION UNIT
46 OUTPUT UNIT
48 WEIGHT SENSOR
54 FIRST MARK
54a FIRST DETECTION REGION
56 SECOND MARK
56a SECOND DETECTION REGION
58 THIRD MARK
58a THIRD DETECTION REGION
60, 62 OCCUPANT

1.-9. (canceled)

10. A seated state detection device comprising:
a detection unit configured to detect, from taken image data output from an imaging unit that images a seat to which a mark is added, whether the mark is shielded;
a state determination unit configured to determine a seated state of the seat based on a shielded state of the mark; and
an output unit configured to output seating information indicating the seated state.

11. The seated state detection device according to claim 10, wherein the detection unit detects, as the mark, whether the mark is shielded based on the taken image data obtained by imaging light of a light emitting element incorporated in the seat.

12. The seated state detection device according to claim 11, wherein the light emitting element forms a pattern of dots arranged in an array.

13. The seated state detection device according to claim 10, wherein the detection unit detects, as the mark, whether the mark is shielded based on the taken image data obtained by imaging the seat to which at least one of a vertical line mark extending in a vertical direction of the seat and a horizontal line mark extending in a horizontal direction of the seat is added.

14. The seated state detection device according to claim 13, wherein at least one of the vertical line mark and the horizontal line mark is formed by arranging dot-like marks.

15. The seated state detection device according to claim 10, wherein
the detection unit detects whether the mark is shielded based on the taken image data obtained by imaging the seat to which a plurality of the marks are added to a plurality of positions, and
the state determination unit acquires at least one of seated/non-seated state information of the seat, physique information of a user seated on the seat, and seated posture information of the user based on the position of the detected mark.

16. The seated state detection device according to claim 10, wherein the detection unit detects whether the mark is shielded based on infrared image data as the taken image data.

17. The seated state detection device according to claim 10, wherein the state determination unit further acquires weight data indicating weight added to the seat, and determines the seated state based on the shielded state of the mark and the weight data.

18. The seated state detection device according to claim 10, wherein
the detection unit further detects a length in a longitudinal direction of the mark, and
the state determination unit determines the seated state based on a position and the length of the detected mark.
